(19) United States
(12) Patent Application Publication
(10) Pub. No.: US 2022/0058693 A1
(43) Pub. Date: Feb. 24, 2022

(54) METHOD, SYSTEM, AND NON-TRANSITORY COMPUTER READABLE RECORD MEDIUM FOR PROVIDING CHATROOM EMBEDDED CONTENT

(71) Applicant: LINE Plus Corporation, Seongnam-si (KR)

(72) Inventors: Yoonwoo JANG, Seongnam-si (KR); Sungwhan Kim, Seongnam-si (KR)

(73) Assignee: LINE Plus Corporation, Seongnam-si (KR)

(21) Appl. No.: 17/409,166

(22) Filed: Aug. 23, 2021

(30) Foreign Application Priority Data
Aug. 24, 2020 (KR) 10-2020-0105905

(51) Int. Cl. G06Q 30/02; H04L 12/58

(52) U.S. Cl. CPC G06Q 30/0269; H04L 51/04; G06F 40/20; G06Q 30/0272; G06Q 30/0277; H04L 51/24

(57) ABSTRACT

A method, system, and non-transitory computer-readable record medium for providing chatroom embedded content are provided. The method implemented by a computer system including at least one processor configured to execute computer-readable instructions stored in a memory, includes receiving a request for entering a chatroom; and displaying content related to the chatroom based on a system message of the chatroom in response to entering the chatroom.

### CROSS-REFERENCE TO RELATED APPLICATION

This application is based on and claims priority under 35 U.S.C. § 119 to Korean Patent Application No. 10-2020-0105905, filed on Aug. 24, 2020 in the Korean Intellectual Property Office, the disclosure of which is incorporated by reference herein in its entirety.

### BACKGROUND

### 1. Field

Apparatuses and methods consistent with example embodiments relate to providing content through a chatroom, and in particular to selectively providing content through a chatroom based on a user's interaction with the chatroom.

### 2. Description of Related Art

An instant messenger is a general communication tool may send and receive messages or data in real time. The instant messenger may also allow a user to register a contact on a messenger and to send and receive messages with a counterpart included in a contact list.

Such functions of an instant messenger make the use of a messenger popular not only in a personal computer (PC) environment but also a mobile environment of a mobile communication terminal.

For example, in the related art, there is proposed a mobile messenger service system and method of a portable terminal using a wireless communication network for providing a messenger service between mobile messengers installed on portable terminals.

As the use of an instant messenger becomes popular and a function provided through an instant messenger becomes more diverse, an open chat capable of making a chat using a link without adding a friend using a telephone number or an ID is available.

### SUMMARY

One or more example embodiments may provide systems capable of securing a new content space by inserting and providing content, such as an advertisement, in a form of a message in a chatroom, and an associate method.

One or more example embodiments also provide a new type of a user interface (UI) in a chatroom by configuring a system message and content as a single set.

One or more example embodiments also provided personalized content based on a category or a hashtag of a chatroom in which a user participates and a point in time at which the user enters the chatroom.

According to an aspect of at least one example embodiment, there is provided a method implemented by a computer system comprising at least one processor configured to execute computer-readable instructions stored in a memory may include receiving a request for entering a chatroom; and displaying content related to the chatroom based on a system message of the chatroom in response to entering the chatroom.

The displaying may include displaying the content and the system message comprised in the chatroom as a single set. The system message may indicate an unread message.

The displaying may include determining whether the chatroom meets a system message display condition in response to entry into the chatroom being requested; and displaying the content along with the system message on a screen of the chatroom based on the chatroom meeting the system message display condition.

The system message display condition may be based on a number of unread messages by a user of the computer system in the chatroom.

The system message display condition is based on a number of unread messages by a user of the computer system in the chatroom and a recent entry time of the user of the computer system for the chatroom.

The method may further include removing the system message and the content from a screen of the chatroom in response to reentry into the chatroom.

The method may further include removing the system message from a screen of the chatroom in response to reentry into the chatroom and maintaining displaying of the content based on one or more reactions to the content.

The maintaining may include determining a display duration time of the content based on a type of the one or more reactions and a number of the one or more reactions.

The displaying may include displaying, on a screen of the chatroom, the content along with the system message, and the content may be targeted for attribute information of the chatroom.

The displaying may include displaying, on a screen of the chatroom, the content along with the system message, and the content may be targeted for at least one of a result of analyzing at least a portion of conversation contents comprised in the chatroom and user profile information.

According to an aspect of at least one example embodiment, there is provided a non-transitory computer-readable record medium storing instructions that, when executed by a processor, cause the processor to perform the method of providing content.

According to an aspect of at least one example embodiment, there is provided a computer system including at least one processor configured to execute computer-readable instructions stored in a memory, the at least one processor may be configured to: receive a request for entering a chatroom, and display content related to the chatroom through based on a system message of the chatroom in response to entering the chatroom.

The at least one processor may be further configured to display the content and the system message comprised in the chatroom as a single set, and the system message may indicate an unread message.

The at least one processor may be further configured to: determine whether the chatroom meets a system message display condition in response to entry into the chatroom is requested, and display the content along with the system message on a screen of the chatroom based on the chatroom meeting the system message display condition.

The system message display condition may be based on a number of unread messages by a user of the computer system in the chatroom.

The system message display condition may be based on a number of unread messages by a user of the computer system in the chatroom and a recent entry time of the user of the computer system for the chatroom.

The at least one processor may be further configured to remove the system message and the content from a screen of the chatroom in response to reentry into the chatroom.

The at least one processor may be further configured to: remove the system message from a screen of the chatroom in response to reentry into the chatroom, and maintain displaying of the content based on one or more reactions to the content.

The at least one processor may be further configured to determine a display duration time of the content based on a type of the one or more reactions and a number of one or more reactions.

The at least one processor may be further configured to display, on a screen of the chatroom, the content along with the system message, and the content may be targeted for attribute information of the chatroom.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of an electronic device according to at least one example embodiment;

FIG. 4 is a flowchart illustrating an example of a content providing method performed by an electronic device according to at least one example embodiment;

FIG. 5 is a flowchart illustrating an example of a process of requesting content according to at least one example embodiment;

FIGS. 6 to 8 illustrate examples of a chatroom screen according to at least one example embodiment; and

FIG. 9 is a flowchart illustrating an example of a content providing method performed by a server according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Example embodiments may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises,” “includes,” “comprising,” and/or “including,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings. The drawings are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

The example embodiments relate to technology for providing content through a chatroom.

The example embodiments including the disclosures described herein may display content, such as an advertisement, as a single set through interaction with a system message of a chatroom and, through this, may secure a content space having been absent and may provide a user interface (UI) in a new form in the chatroom.

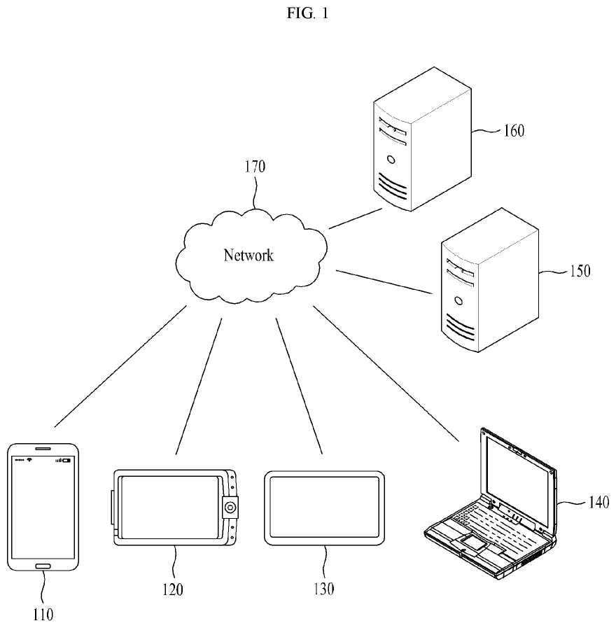

FIG. 1 is a diagram of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 shows a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, for example, the server 150 may provide, as the first service, a service (e.g., a messaging service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

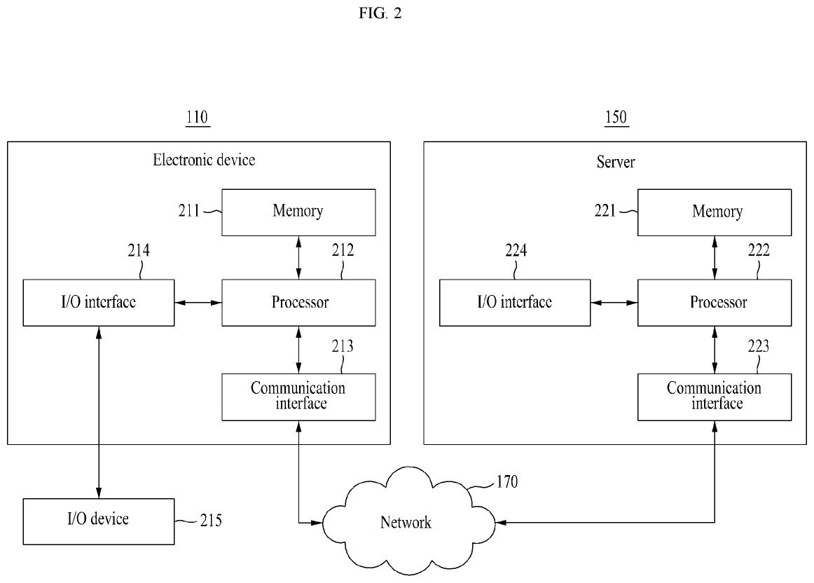

FIG. 2 is a block diagram of an electronic device and a server according to at least one example embodiment. Description is made using the electronic device 110 as an example of an electronic device and the server 150 as an example of a server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication interface 213, and an input/output (I/O) interface 214, and the server 150 may include a memory 221, a processor 222, a communication interface 223, and an I/O interface 224. The memory 211, 221 may include a permanent mass storage device, such as a random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS and at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the electronic device 110 and the server 150 over the network 170 and may provide a function for communication between the electronic device 110 and/or the server 150 and another electronic device, for example, the electronic device 120 or another server, for example, the server 160. For example, the processor 212 of the electronic device 110 may forward a request created based on a program code stored in the storage device such as the memory 211, to the server 150 over the network 170 under control of the communication interface 213. Inversely, a control signal, an instruction, content, a file, etc., provided under control of the processor 222 of the server 150 may be received at the electronic device 110 through the communication interface 213 of the electronic device 110 by going through the communication interface 223 and the network 170. For example, a control signal, an instruction, content, a file, etc., of the server 150 received through the communication interface 213 may be forwarded to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to other example embodiments, the electronic device 110 and the server 150 may include a number of components greater than or less than a number of components shown in FIG. 2. However, there is no need to clearly illustrate many components according to the related art. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, example embodiments of a method and system for providing chatroom embedded content are described.

The term “chatroom” used herein may refer to an interface screen for providing messages exchanged between users. As a representative example of the chatroom, the chatroom may include, for example, an interface screen of a chat function capable of exchanging messages through a communication session established between accounts of users in a messenger or a social network service (SNS), an interface screen of an open chat function capable of making a chat (sending a message) using a link such as a universal resource locator (URL) without adding a friend using a telephone number or an ID, and the like. An open chat link may include a function for executing a chatroom of a corresponding link in response to an automatic execution of a messenger, in order to make an immediate chat in response to a click on the link.

Although example embodiments of a chatroom of a messenger are described below, they are provided as an example only. Any conversation-based interfaces of a service in which a plurality of users participate and a new participation frequently occurs based on an account or a telephone number of a user as well as a link may be applied.

The term “content” used herein may inclusively refer to a variety of information or contents having a desired purpose, which is created based on at least one of a character, a symbol, an image, a video, and an audio, and provided through the Internet or computer communication.

Hereinafter, although an advertisement is described as a representative example of content, it is provided as an example only. Any type of content that may be provided through insertion into a chatroom through interaction with a messaging service may apply.

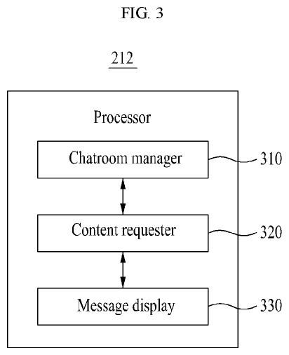

FIG. 3 is a diagram of components of a processor of an electronic device according to at least one example embodiment.

A computer-implemented content providing system may be configured in the electronic device 110 according to the example embodiment. For example, the content providing system may be configured as a program form that independently operates or may be configured as an in-app form of a specific application to be operable on the specific application and may provide a messaging service through interaction with the server 150.

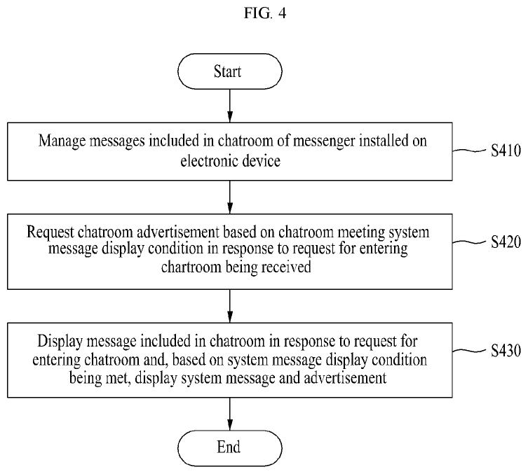

The content providing system implemented in the electronic device 110 may perform the content providing method of FIG. 4 in response to an instruction provided from the application installed on the electronic device 110.

Referring to FIG. 3, to perform the content providing method of FIG. 4, the processor 212 of the electronic device 110 may include a chatroom manager 310, a content requester 320, and a message display 330. Depending on example embodiments, the components of the processor 212 may be selectively included in or excluded from the processor 212. Also, depending on example embodiments, the components of the processor 212 may be separated or merged for representations of functions of the processor 212.

The processor 212 and the components of the processor 212 may control the electronic device 110 to perform operations included in the content providing method according to example embodiments. For example, the processor 212 and the components of the processor 212 may be configured to execute an instruction according to a code of at least one program and a code of an OS included in the memory 211.

Here, the components of the processor 212 may be representations of different functions of the processor 212 performed by the processor 212 in response to an instruction provided from the program code stored in the electronic device 110, for example, an instruction provided from an application executed on the electronic device 110. For example, the chatroom manager 310 may be used as a functional representation of the processor 212 that controls the electronic device 110 to manage a message included in a chatroom in response to the instruction.

FIG. 4 is a flowchart of a content providing method performed by an electronic device according to at least one example embodiment.

The processor 212 may read a necessary instruction from the memory 211 to which instructions associated with control of the electronic device 110 are loaded. In this case, the read instruction may include an instruction for controlling the processor 212 to perform the content providing method disclosed herein.

Referring to FIG. 4, in operation 5410, the chatroom manager 310 may manage messages included in a chatroom of a messenger installed on the electronic device 110. That is, the chatroom manager 310 may manage messages sent and received through each chatroom in association with a corresponding chatroom for each chatroom of the messenger.

In particular, the chatroom manager 310 may manage a message that is not read by a user of the electronic device 110 and not processed as being read, that is, an unread message among messages included in the chatroom. For example, the chatroom manager 310 may count and manage a number of unread messages in each chatroom. As another example, the chatroom manager 310 may count and manage a number of unread messages in each chatroom and a time (hereinafter, a recent entry time) at which a last read mode of a corresponding chatroom is executed.

In operation S420, with respect to a specific chatroom in which an unread message is present, the content requester 320 may request a chatroom related advertisement based on the corresponding chatroom meeting the system message display condition at a point in time at which (or in response to) the request for entering the corresponding chatroom is received from the user of the electronic device 110. When the user of the electronic device 110 enters a chatroom in which an unread message is present, a system message indicating the unread message may be displayed on a screen of the corresponding chatroom. Here, the content requester 320 may determine whether the corresponding chatroom meets the system message display condition at a point in time at which a request for entering the chatroom is received from the user of the electronic device 110 and, when the corresponding chatroom meets the system message display condition, the content requester 320 may forward, to the server 150, an advertisement request with chatroom information, for example, a chatroom ID capable of identifying the corresponding chatroom.

The system message may refer to a message that is autonomously output from the computer system in response to an instruction provided from the messenger installed on the computer system. Here, the system message by the unread message may refer to a single message type displayed on a screen of the chatroom and may be an unread message mark representing presence of the unread message.

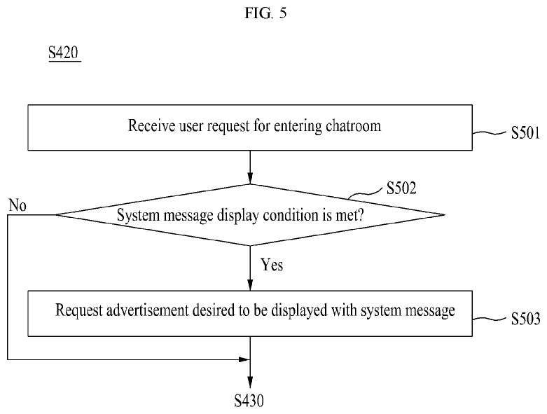

FIG. 5 is a flowchart of a process of requesting content according to at least one example embodiment. For example, referring to FIG. 5, in operation S501, the content requester 320 may receive a user request for entering the chatroom from the electronic device 110 with respect to the chatroom in which the unread message is present. In operation S502, the content requester 320 may determine whether the chatroom the user desires to enter meets a system message display condition in response to the request for entering the chatroom. When the chatroom the user desires to enter meets the system message display condition, the content requester 320 may request the server 150 for an advertisement desired to be displayed with the system message in operation S503.

When an unread message-based display condition is met, the system message may be displayed before a first received message among unread messages. Here, a number of unread messages may be used as the system message display condition. If the number of unread messages in the chatroom is greater than or equal to a desired number, for example, 9, the processor 212 may display the system message on a screen of the corresponding chatroom at a time of entering the chatroom. A recent entry time of the chatroom may be additionally used as the system message display condition with the number of unread messages. Although, when the number of unread messages is less than the desired number for the chatroom in which the unread message is present, the system message may be displayed before the unread message if the recent entry time of the chatroom elapses a preset period of time, for example, 1 day. Unless the system message display condition is met, the system message is not displayed even after entering the chatroom in which the unread message is present.

The content requester 320 may request an advertisement desired to be displayed with the corresponding system message for every system message indicating the unread message.

Referring again to FIG. 4, in operation S430, the message display 330 may display a message included in the corresponding chatroom on the screen of the chatroom in response to entry into the screen of the chatroom in response to the request for entering the chatroom. When the chatroom meets the system message display condition, the message display 330 may display the system message and an advertisement before the unread message on the screen of the chatroom.

In particular, the message display 330 may receive an advertisement related to the corresponding chatroom from the server 150 in response to the request for entering the chatroom and may group and display the advertisement as a single set with the system message and may sequentially display the system message and the unread message. Therefore, in the case of entering the chatroom in which unread messages are accumulated, the message display 330 may display the advertisement with a functional benefit of providing an unread message mark in displaying the unread messages on the screen of the chatroom.

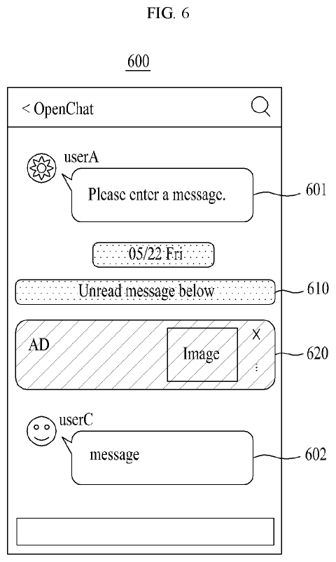

FIGS. 6 through 8 show examples of a chatroom screen according to at least one example embodiment.

Referring to FIG. 6, in the case of entering a chatroom screen 600 in a state in which unread messages are accumulated, the message display 330 may display a system message 610 and an advertisement 620 between a most recent message, that is, a last read message 601 among read messages processed as being read and a first received message, that is, a first unread message 602 among unread messages on a central area of the chatroom screen 600.

The message display 330 may process the advertisement 620 as a content message type that is a separate message type and may display the advertisement 620 to be distinguished from a different type of a message in a chatroom.

The advertisement 620 may be inserted in a chatroom embedded banner and displayed on the chatroom screen 600 with the system message 610. The message display 330 may display the advertisement 620 through interaction with the system message 610 at a time of entering the chatroom screen 600 to read an unread message.

The advertisement 620 may be displayed as an embedded advertisement in the chatroom, and may be displayed, for example, in a scrollable form with other messages in the chatroom.

The advertisement 620 may include an image, a video, a related page link, and the like, as corresponding advertising content. The advertisement 620 may include a close button for closing the advertisement 620 on the chatroom screen 600 and may include a menu capable of setting an advertisement-related option, for example, an option of blocking advertisements of an advertiser corresponding to the advertisement 620 or advertisements of similar or same category as that of the advertisement 620.

Since each user differently enters the chatroom, the advertisement 620 displayed on the chatroom screen 600 may be different for each user and a point in time and a position at which the advertisement 620 is displayed may be different for each user. That is, the advertisement 620 provided in a chatroom embedded form may be personalized for each user and a display point in time or a display position of the advertisement 620 may also be personalized.

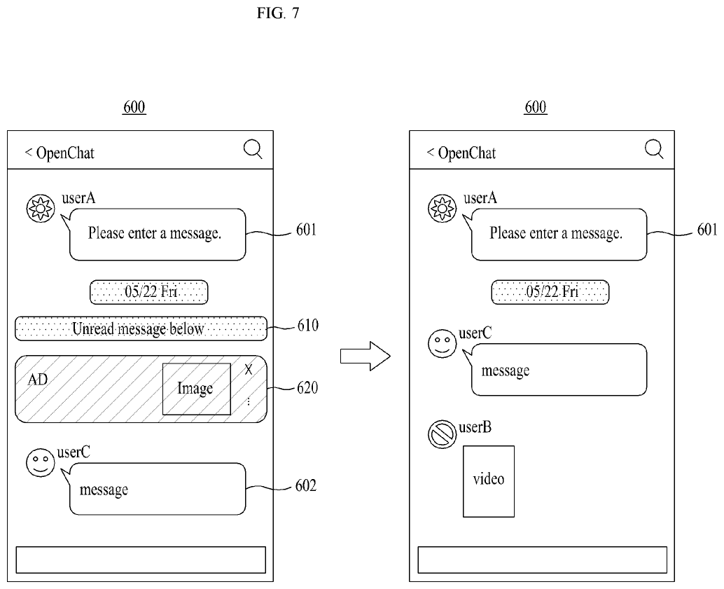

Referring to FIG. 7, in the case of leaving and then reentering the chatroom screen 600 after verifying all of the unread messages, the message display 330 may process the system message 610 by the existing unread message and the advertisement 620 to be invisible on the chatroom screen 600. In the case of reentry into the chatroom screen 600, the system message 610 and the advertisement 620 may disappear on the chatroom screen 600.

Depending on example embodiments, in the case of reentering the chatroom screen 600, the message display 330 may process the system message 610 by the existing unread message to disappear and may maintain displaying of the advertisement 620 or may process the advertisement 620 to disappear with the system message 610 by determining whether to display the advertisement 620.

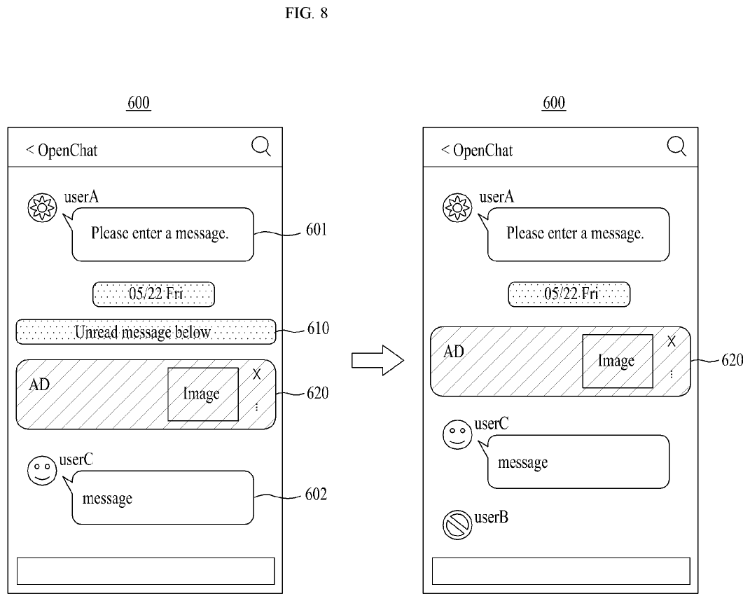

Referring to FIG. 8, in the case of leaving and then reentering the chatroom screen 600 after verifying all of the unread messages, the message display 330 may process the system message 610 by the existing unread message to be invisible on the chatroom screen 600 and may maintain displaying of the advertisement 620.

For example, in the case of receiving a reaction, for example, a click, a reply, and a mention, to the advertisement 620 from the user of the electronic device 110 or at least one chat partner participating in the chatroom, the message display 330 may maintain displaying of the advertisement 620 in response to reentry into the chatroom screen 600.

As another example, in the case of reentering the chatroom screen 600 after determining a display duration time of the advertisement 620 based on a type of a reaction or a number of reactions to the advertisement 620, the message display 330 may maintain displaying of the advertisement 620 for the determined display duration time. The message display 330 may differently apply the display duration time of the advertisement 620 based on the type of reaction or may maintain the advertisement 620 to be displayed for a relatively long period of time according to an increase in the number of reactions.

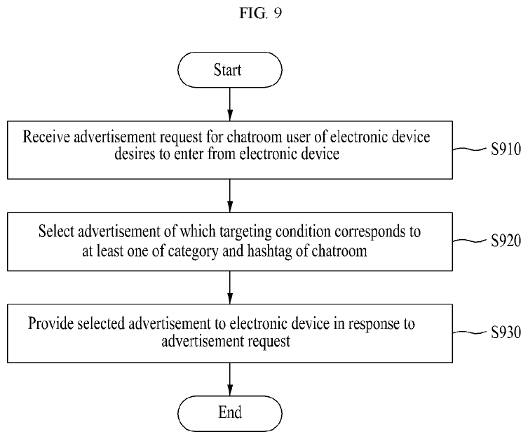

FIG. 9 is a flowchart of a content providing method performed by a server according to at least one example embodiment.

The processor 222 may read a necessary instruction from the memory 221 to which instructions associated with control of the server 150 are loaded. In this case, the read instruction may include an instruction for controlling the processor 222 to perform the content providing method according to at least one example embodiment.

Referring to FIG. 9, in operation S910, the processor 222 may receive an advertisement request for a chatroom (hereinafter, a specific chatroom) the user of the electronic device 100 desires to enter from the electronic device 100. The advertisement request may include user information, for example, a user ID, for identifying the user of the electronic device 100 and chatroom information, for example, a chatroom ID, for identifying the specific chatroom.

In operation S920, the processor 222 may select an advertisement that meets a targeting condition from among advertisements registered to a database included as an internal component of the server 150 or to a database interactable with the server 150.

For example, the processor 222 may select an advertisement based on attribute information, for example, a name, a category, and a hashtag, of the specific chatroom associated with the advertisement request received in operation S910. The processor 222 may select an advertisement corresponding to the advertisement request through category-based targeting or hashtag-based targeting. The processor 222 may acquire a category to which the specific chatroom belongs or a hashtag set to the specific chatroom based on the chatroom information included in the advertisement request and may select an advertisement targeted to the corresponding category information or hashtag.

As another example, the processor 222 may select an advertisement corresponding to the advertisement request through user profile-based targeting. The processor 222 may verify a user profile, that is, user demo information, based on the user information included in the advertisement request and may select an advertisement targeted to the user profile. Further, the processor 222 may select an advertisement corresponding to the advertisement request through further sophisticated targeting by combining the user profile-based targeting with the category-based targeting or the hashtag-based targeting.

As another example, the processor 222 may analyze at least a portion of conversation contents, for example, a preset recent period of time or a preset number of messages, included in the specific chatroom and may use a conversation analysis result for advertisement targeting. Further, the processor 222 may select an advertisement corresponding to the advertisement request through further sophisticated targeting by combining the conversation analysis result with the category-based targeting or the hashtag-based targeting.

The aforementioned targeting logic is provided as an example only. At least one targeting condition may be applied, and known advertisement targeting technology may be used.

In operation S930, the processor 222 may provide the advertisement selected in operation S920 to the electronic device 110 as the advertisement corresponding to the advertisement request from the electronic device 110. When the user desires to enter the specific chatroom in which an unread message is present, the electronic device 110 may call an advertisement related to the specific chatroom from the server 150 at a corresponding point in time and may display a system message by the unread message and the advertisement provided from the server 150 in a user interface (UI) form configured as a single set on a screen of the specific chatroom.

Although it is described that a process of verifying an unread message and determining an advertisement display point in time based on the unread message is executed on a side of a client and a process of selecting and providing an advertisement is executed on a side of the server 150, it is provided as an example only. For example, a process of verifying an unread message for each chatroom of the messenger installed on the electronic device 110 and determining the advertisement display point in time based on the unread message may be configured to be executed by the server 150.

According to some example embodiments, it is possible to provide content such as an advertisement by inserting the content in a form of a message in a chatroom. In particular, it is possible to provide a new type of a UI in the chatroom as a chatroom embedded banner type by configuring the content and a system message as a single set.

According to some example embodiments, it is possible to provide personalized content through targeting based on attribute information, for example, a chatroom name, a category, or a hashtag, of a chatroom in which a user participates, user profile information, and a result of analyzing conversation contents in the chatroom. In particular, it is possible to provide the content at a point in time of entering the chatroom in which an unread message is present and also to provide the content in a state in which a display time or a display position is personalized.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method implemented by a computer system comprising at least one processor configured to execute computer-readable instructions stored in a memory, the method comprising:
receiving a request for entering a chatroom; and
displaying content related to the chatroom based on a system message of the chatroom in response to entering the chatroom.

2. The method of claim 1, wherein the displaying comprises displaying the content and the system message comprised in the chatroom as a single set, and
wherein the system message indicates an unread message.

3. The method of claim 1, wherein the displaying comprises:
determining whether the chatroom meets a system message display condition in response to entry into the chatroom being requested; and
displaying the content along with the system message on a screen of the chatroom based on the chatroom meeting the system message display condition.

4. The method of claim 3, wherein the system message display condition is based on a number of unread messages by a user of the computer system in the chatroom.

5. The method of claim 3, wherein the system message display condition is based on a number of unread messages by a user of the computer system in the chatroom and a recent entry time of the user of the computer system for the chatroom.

6. The method of claim 1, further comprising:
removing the system message and the content from a screen of the chatroom in response to reentry into the chatroom.

7. The method of claim 1, further comprising:
removing the system message from a screen of the chatroom in response to reentry into the chatroom and maintaining displaying of the content based on one or more reactions to the content.

8. The method of claim 7, wherein the maintaining comprises determining a display duration time of the content based on a type of the one or more reactions and a number of the one or more reactions.

9. The method of claim 1, wherein the displaying comprises displaying, on a screen of the chatroom, the content along with the system message, and
wherein the content is targeted for attribute information of the chatroom.

10. The method of claim 1, wherein the displaying comprises displaying, on a screen of the chatroom, the content along with the system message, and
wherein the content is targeted for at least one of a result of analyzing at least a portion of conversation contents comprised in the chatroom and user profile information.

11. A non-transitory computer-readable record medium storing instructions that, when executed by a processor, cause the processor to perform the method of claim 1 on the computer system.

12. A computer system comprising:
at least one processor configured to execute computer-readable instructions stored in a memory,
wherein the at least one processor is configured to:
receive a request for entering a chatroom, and
display content related to the chatroom through based on a system message of the chatroom in response to entering the chatroom.

13. The computer system of claim 12, wherein the at least one processor is further configured to display the content and the system message comprised in the chatroom as a single set, and
wherein the system message indicates an unread message.

14. The computer system of claim 12, wherein the at least one processor is further configured to:
determine whether the chatroom meets a system message display condition in response to entry into the chatroom is requested, and
display the content along with the system message on a screen of the chatroom based on the chatroom meeting the system message display condition.

15. The computer system of claim 14, wherein the system message display condition is based on a number of unread messages by a user of the computer system in the chatroom.

16. The computer system of claim 14, wherein the system message display condition is based on a number of unread messages by a user of the computer system in the chatroom and a recent entry time of the user of the computer system for the chatroom.

17. The computer system of claim 12, wherein the at least one processor is further configured to remove the system message and the content from a screen of the chatroom in response to reentry into the chatroom.

18. The computer system of claim 12, wherein the at least one processor is further configured to:
remove the system message from a screen of the chatroom in response to reentry into the chatroom, and
maintain displaying of the content based on one or more reactions to the content.

19. The computer system of claim 18, wherein the at least one processor is further configured to determine a display duration time of the content based on a type of the one or more reactions and a number of one or more reactions.

20. The computer system of claim 12, wherein the at least one processor is further configured to display, on a screen of the chatroom, the content along with the system message, and
wherein the content is targeted for attribute information of the chatroom.
